(19) United States
(12) Patent Application Publication
(10) Pub. No.: US 2018/0021108 A1
(43) Pub. Date: Jan. 25, 2018

(54) ORTHODONTIC APPLIANCE INCLUDING ARCH MEMBER

(71) Applicant: 3M INNOVATIVE PROPERTIES COMPANY, St. Paul, MN (US)

(72) Inventors: David K. Cinader, Jr., Woodbury, MN (US); Ralf M. Paehl, Melle (DE); Michael K. Domroese, Woodbury, MN (US); Gopal B. Haregoppa, Woodbury, MN (US); James D. Hansen, White Bear Lake, MN (US)

(21) Appl. No.: 15/548,474

(22) PCT Filed: Mar. 7, 2016
(86) PCT No.: PCT/US2016/021239

§ 371 Date: Aug. 3, 2017

Related U.S. Application Data
(60) Provisional application No. 62/133,133, filed on Mar. 13, 2015.

(51) Int. Cl. A61C 7/20; A61C 7/14

(52) U.S. Cl. CPC A61C 7/20; A61C 7/146; A61C 7/145; A61C 7/08

(57) ABSTRACT

Various embodiments of an orthodontic appliance and method of forming such appliance are disclosed. In one or more embodiments, the orthodontic appliance can include an arch member including an arch member body and an arch member coupling connected to the body. The orthodontic appliance can also include an anchor including an anchor coupling and a base adapted to connect the anchor to a surface of a tooth. The arch member coupling can be releasably connectable to the anchor coupling, and the anchor can be adapted for displacement relative to the arch member body when the anchor is connected to the surface of the tooth and the arch member coupling is connected to the anchor coupling.

### BACKGROUND

Orthodontics is the area and specialty of dentistry associated with the supervision, guidance, and correction of malpositioned teeth into proper locations. Orthodontic treatment can be useful in correcting defects in a patient's bite (also called occlusion) along with promoting better hygiene and improving the overall aesthetics and health of the teeth.

Orthodontic treatment often involves the use of slotted appliances known as brackets, which are generally affixed to the patient's anterior, cuspid, and bicuspid teeth. After the brackets have been placed on the teeth, an archwire is received into a slot of each bracket. The archwire can act as a track to guide the movement of respective teeth to orthodontically correct positions. End sections of the archwire are typically captured in appliances known as buccal tubes that are affixed to the patient's molar teeth. The brackets, archwires, and buccal tubes are typically referred to collectively as “braces.”

Conventional braces, however, have inherent limitations. For example, brackets and wires in the mouth tend to trap food and plaque, especially in areas behind the archwire and beneath bracket tiewings. The poor oral hygiene that results from plaque build-up, in turn, can lead to additional problems, including tooth decay, gingivitis, periodontal disease, etc. Plaque build-up adjacent the brackets in particular can also cause decalcification and so-called “white spot” lesions on enamel surfaces of teeth that remain even after the braces are removed at the conclusion of treatment.

Removable appliances can significantly alleviate some of these problems because the appliances can be removed from the mouth while eating and/or brushing. Not only do removable appliances facilitate the maintenance and cleaning of the teeth, they also facilitate cleaning of the appliance. Popular removable appliances include polymeric aligner shells manufactured by Align Technology (Santa Clara, Calif.), which are intended to incrementally and progressively re-position teeth to a desired teeth arrangement. Other types include wire-embedded appliances such as those based on the Hawley retainer or Crozat appliance, which typically use metal wires that passively contact the teeth surfaces. While these appliances can be used to provide corrective tooth movements, they are most commonly used for retention of teeth after correction has been completed. Spring aligners, also called spring retainers, which combine aspects of both clear aligners and wire-embedded retainers, can be used for orthodontic correction. These aligners, however, are limited in the types of forces they can apply to teeth, which in turn can limit the breadth of dental malocclusions that can be treated.

### SUMMARY

In general, the present disclosure provides various embodiments of an orthodontic appliance and a method of forming such appliance. In one or more embodiments, the appliance can include one or more anchors and an arch member. Each anchor can include an anchor coupling and a base adapted to connect the anchor to a surface of a tooth. Further, the arch member can include an arch member body and one or more couplings connected to the body. The arch member coupling can be releasably connectable to the anchor coupling. Further, in one or more embodiments, the anchor can be adapted for displacement relative to the arch member body when the anchor is connected to the surface of the tooth and the arch member coupling is connected to the anchor coupling.

In one aspect, the present disclosure provides an orthodontic appliance that includes a first anchor including an anchor coupling and a base adapted to connect the first anchor to a surface of a first tooth, and a second anchor including an anchor coupling and a base adapted to connect the second anchor to a surface of a second tooth. The appliance also includes an arch member including an arch member body and first and second arch member couplings connected to the body. The first arch member coupling is releasably connectable to the anchor coupling of the first anchor and the second arch member coupling is releasably connectable to the anchor coupling of the second anchor. Further, the arch member body includes a first nonlinear portion between the first arch member coupling and the second arch member coupling that is adapted to be spaced apart from the surfaces of the first and second teeth when the first and second anchors are connected to the surfaces of the first and second teeth and the first and second arch member couplings are releasably connected to the anchor couplings of the first and second anchors. The first anchor is adapted for displacement relative to the arch member body such that the anchor can slide relative to the arch member body when the first and second anchors are connected to the surfaces of the first and second teeth and the first and second arch member couplings are releasably connected to the anchor couplings of the first and second anchors.

In another aspect, the present disclosure provides a method of forming an orthodontic appliance. The method includes providing a proposed specification of the orthodontic appliance, where the orthodontic appliance includes an arch member that includes an arch member body and an arch member coupling connected to the arch member body, and a set of anchors. Each anchor includes an anchor coupling and a base adapted to connect the anchor to a surface of a tooth, where each arch member coupling is releasably connectable to an anchor coupling, and further where at least one anchor of the set of anchors is adapted for displacement relative to the arch member body such that the at least one anchor can slide relative to the arch member body when the anchor is connected to the surface of the tooth and the anchor coupling is connected to an arch member coupling of the arch member. The method further includes providing a first digital image representing a first dental arrangement associated with the orthodontic appliance, deriving a target digital image representing a target dental arrangement, revising the proposed specification of the orthodontic appliance based at least in part on the target digital image, and forming the orthodontic appliance based on the target digital image.

In another aspect, the present disclosure provides an orthodontic treatment system including an orthodontic appliance. The orthodontic appliance includes a set of arch members, each arch member including an arch member body and an arch member coupling connected to the body. The appliance further includes a set of anchors adapted to connect to respective teeth of a patient's dental arch, each anchor including an anchor coupling and a base adapted to connect the anchor to a surface of a tooth. The arch member coupling is releasably connectable to an anchor coupling of an anchor of the set of anchors. Further, the anchor of the set of anchors is adapted for displacement relative to an arch member body of the arch member such that the anchor can slide relative to the arch member body when the anchor is connected to the surface of the tooth and the arch member coupling of the arch member is connected to the anchor coupling of the anchor. The arch member body is adapted to not contact the surface of the tooth. Further, a first arch member of the set of arch members has a geometry selected to move at least one tooth from a first arrangement to a second arrangement, and a second arch member of the set of arch members has a geometry selected to move at least one tooth from the second arrangement to a third arrangement.

In another aspect, the present disclosure provides an orthodontic appliance that includes an arch member including an arch member body and a plurality of arch member couplings connected to the body, and a plurality of anchors each including an anchor coupling and a base adapted to connect the anchor to a surface of a tooth. Each arch member coupling is releasably connectable to the anchor coupling of an anchor of the plurality of anchors. At least one anchor is adapted for displacement relative to the arch member body such that the at least one anchor can slide relative to the arch member body when the anchor is connected to the surface of the tooth and an arch member coupling of the plurality of arch member couplings is connected to the anchor coupling. Further, the arch member body includes a first shape between two arch member couplings that is different from a second shape between two additional arch member couplings. The arch member body is adapted to not contact the surface of the tooth when the anchor of the plurality of anchors is connected to the surface of the tooth.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The use of the term “and/or” in certain portions of this disclosure is not intended to mean that the use of “or” in other portions cannot mean “and/or.”

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### Glossary

The terms set forth herein will have the meanings as defined:

“adapted for displacement” means that an anchor of an orthodontic appliance is designed such that it is able to move relative to an arch member body that is connected to the anchor. The movement of the anchor relative to the arch member body can be translational, rotational, and a combination of translational and rotational movement. Further, the movement of the anchor relative to the arch member body can be in any plane and along any desired path;

“angulation” means the tilt of the long axis of the tooth in a mesial or distal direction;

“cross-sectional geometry” means a cross-sectional shape of an arch member body taken in a plane orthogonal to a length of the arch member body;

“corrective force” means a force or forces applied to one or more of a patient's teeth by an orthodontic appliance;

“distal” means in a direction away from the center of the patient's curved dental arch;

“facial” means in a direction toward the patient's lips or cheeks;

“gingival” means in a direction toward the patient's gums or gingiva;

“inclination” means the tilt of the long axis of a tooth in the buccolingual or faciolingual direction;

“lingual” means in a direction toward the patient's tongue;

“mesial” means in a direction toward the center of the patient's curved dental arch;

“occlusal” means in a direction toward the outer tips of the patient's teeth;

“releasably connectable” means that an arch member coupling can be connected to an anchor coupling of an anchor such that an arch member connected to the arch member coupling remains attached to the anchor and that the arch member coupling can be disconnected from the anchor coupling using an appropriate amount of force without destroying or altering the anchor coupling;

“rotation” means turning of a tooth by movement around its long axis;

“self ligating” means that an arch member can be connected to one or more anchors that are connected to surfaces of one or more teeth without the need for use of additional ties, wires, clamps, or other devices that fix the arch member in place; and

“torque” means a corrective force that changes the inclination of the tooth.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of a portion of one embodiment of an orthodontic appliance connected to surfaces of one or more teeth of a patient.

FIG. 2 is a schematic perspective view of an arch member coupling and an anchor coupling of the orthodontic appliance of FIG. 1.

FIG. 3 is a schematic perspective view of an arch member coupling of the orthodontic appliance of FIG. 1.

FIG. 4 is a schematic perspective view of an anchor and an arch member coupling that is releasably connectable to an anchor coupling of the anchor.

FIG. 5 is a schematic perspective view of an anchor secured to the dental arch according to another embodiment of the disclosure;

FIG. 6 is a schematic perspective view of an arch member coupling of an orthodontic appliance of connected to the anchor coupling of the anchor of FIG. 5.

FIG. 7 is a schematic perspective view of a portion of another embodiment of an orthodontic appliance.

FIG. 8 is a schematic side view of an anchor coupling of an anchor connected to an arch member coupling of an arch member of the orthodontic appliance of FIG. 7.

FIG. 9 is a schematic perspective view of a portion of one embodiment of an arch member.

FIG. 10 is a schematic perspective view of a portion of another embodiment of an arch member.

FIG. 11 is a schematic perspective view of a portion of another embodiment of arch members according to other embodiments.

FIG. 12 is a schematic perspective view of a portion of another embodiment of arch members according to other embodiments.

### DETAILED DESCRIPTION

In general, the present disclosure provides various embodiments of an orthodontic appliance and a method of forming such appliance. In one or more embodiments, the appliance can include one or more anchors and an arch member. Each anchor can include an anchor coupling and a base adapted to connect the anchor to a surface of a tooth. Further, the arch member can include an arch member body and one or more couplings connected to the body. The arch member coupling can be releasably connectable to the anchor coupling. Further, in one or more embodiments, the anchor can be adapted for displacement relative to the arch member body when the anchor is connected to the surface of the tooth and the arch member coupling is connected to the anchor coupling.

Current removable appliances, while offering certain hygiene benefits, can also have shortcomings related to treatment efficacy. Polymeric shells, for example, tend to be limited in their ability to correct particular dental malocclusions. Further, extrusion, gap closure, and molar teeth movement can be difficult or impossible to achieve because these shells rely on relatively weak mechanical retention between the shell and the teeth. Further, polymeric shells may not be entirely aesthetic even when clear since they still cover the facial teeth surfaces and can stain or trap dark liquids such as coffee. On the other hand, retainer-like appliances that use springs or clasps that engage with teeth suffer from many of the same shortcomings as polymeric shells. These appliances, as a whole, may not positively engage with the teeth in a manner that allows precise torque, angulation, rotation, and translation control. Further, many of these appliances are generally not aesthetic as they use a facial wire residing over the facial surface of the teeth to prevent proclination of the teeth.

One or more embodiments of orthodontic appliances described herein can be easily installed and removed by a practitioner as the appliance can be self-ligating, i.e., an arch member of the appliance can be connected to one or more anchors that are connected to surfaces of one or more teeth without the need for use of additional ties, wires, clamps, or other devices that fix the arch member in place. Further, in one or more embodiments where the appliance is adapted to be connected to a lingual surface of one or more teeth of a patient, the appliance can be more aesthetically pleasing than clear aligners as the appliance is at least partially hidden from view by the patient's teeth.

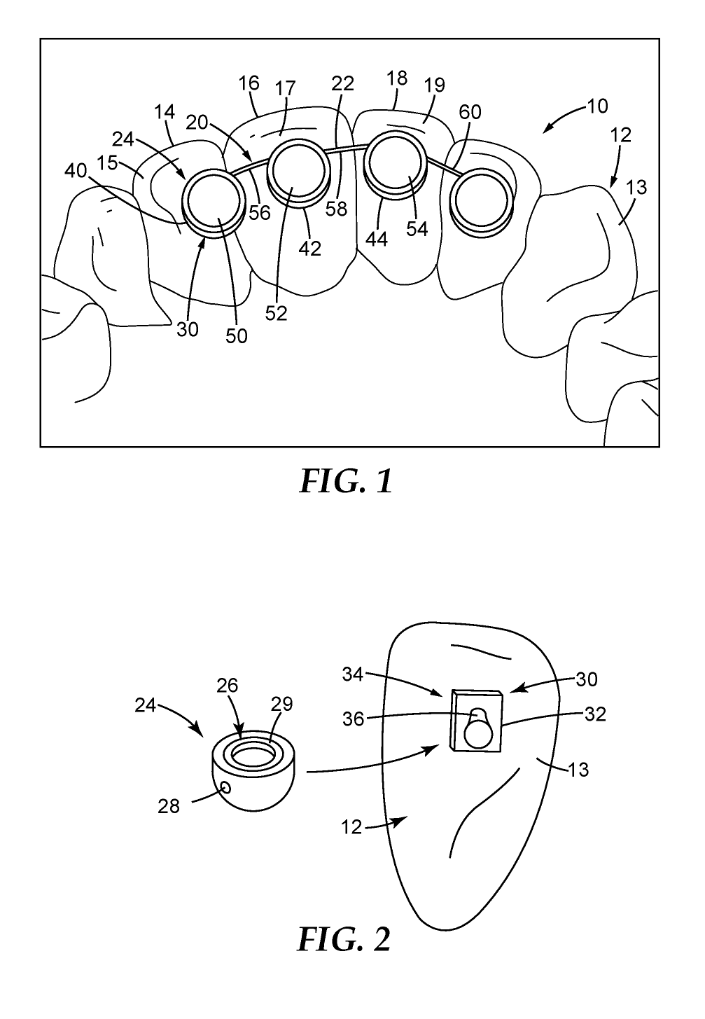

FIGS. 1-3 are various schematic views of one embodiment of an orthodontic appliance 10. The appliance 10 is shown in FIG. 1 connected to one or more teeth 12 of a patient. The appliance 10 can include one or more anchors 30, where one or more anchors can include an anchor coupling 34 and a base 32 adapted to connect the anchor to a surface 13 of a tooth 12 (FIG. 2). The appliance 10 can also include an arch member 20 that includes an arch member body 22 and one or more arch member couplings 24 connected to the arch member body. As is further described herein, the arch member coupling 24 can be releasably connectable to the anchor coupling 34.

At least one anchor 30 can include an anchor coupling 34 and a base 32 adapted to connect the anchor to a surface 13 of a tooth 12. For example, the appliance 10 can include a first anchor 40, a second anchor 42, and a third anchor 44. The first anchor 40 can include an anchor coupling 34 and a base 32 adapted to connect the respective anchor to a surface 15 of a first tooth 14. The second anchor 42 can include an anchor coupling 34 and a base 32 adapted to connect the second anchor to a surface 17 of a second tooth 16. And the third anchor 44 can include an anchor coupling 34 and a base 32 adapted to connect the third anchor to a surface 17 of a third tooth 18. Further, the arch member 20 can include a first arch member coupling 50, a second arch member coupling 52, and a third arch member coupling 54. The first arch member coupling 50 can be releasably connectable to the anchor coupling 34 of the first anchor 40, the second arch member coupling 52 can be releasably connectable to the anchor coupling 34 of the second anchor 42, and the third arch member coupling 54 can be releasably connectable to the anchor coupling 34 of the third anchor 44.

The anchor 30 can be attached to the surface 14 of tooth 12 using any suitable technique or combination of techniques. For example, the anchor 30 can be bonded to a surface of tooth 12 using a suitable adhesive or cement. In one or more embodiments, anchors 30 can be accurately placed and bonded in precise, pre-selected positions on the tooth surfaces of a patient (e.g., the lingual surfaces). To this end, it can be advantageous to use indirect techniques such as those described in U.S. Pat. No. 7,020,963 (Cleary et al.) and U.S. Pat. No. 7,404,714 (Cleary et al.), and U.S. Patent Publication No. 2006/0177791 (Cinader et al.).

The anchor 30 can include an anchor coupling 34 that can take any suitable shape or combination of shapes and have any suitable dimension. In the embodiment illustrated in FIGS. 1-3, the anchor coupling 34 includes the post 36 that extends from the base 32 of the anchor 30. The post 36 can take any suitable shape or combination of shapes. In the illustrated embodiment, the post 36 includes a spherical shape that is adapted to engage the recess 26 of the arch member coupling 24. In one or more embodiments, the anchor coupling 34 can have any suitable cross-sectional shape and dimension. For example, in one or more embodiments, the anchor coupling 34 can have a polygonal, elliptical, or frusto-conical cross-sectional shape. The anchor coupling 34 can have a constant cross-sectional shape and size along a length of the anchor coupling that extends from the base 32 of the anchor 30. In one or more embodiments, the anchor coupling 34 can have a cross-sectional shape that varies along the length of the anchor coupling.

The anchors 30 can be shaped such that any suitable corrective force can be applied to the attached tooth. For example, in one or more embodiments, the post 36 can be formed or disposed on the base 32 such that it extends along an axis that forms any suitable angle with a normal to the tooth surface 12 in a plane orthogonal to the mesio-distal direction. By selecting the appropriate angle, a corrective force can be applied by the arch member 20 to the tooth that can correct for an angulation of the attached tooth. In one or more embodiments, the axis along which the post 36 extends can be formed or disposed such that it forms an angle with a normal to the tooth surface in a plane parallel to the mesio-distal direction. By selecting the appropriate angle, a corrective force can be applied by the arch member 20 to the tooth that can correct for a rotation of the tooth 12. In one or more embodiments, the post 36 can be formed or disposed such that it forms an angle with both of these planes to provide a corrective force that can correct both an angulation and a rotation of the tooth 12.

The anchor 30 can include any suitable material or combination of materials. For example, the anchor 30 can include metallic material, polymeric material, glass material, and combinations thereof. In one or more embodiments, the anchor 30 can include the same materials as described for the arch member body 22. The anchor 30 can also take any suitable shape or combination of shapes such that the base is adapted to connect the anchor to a surface of a tooth and releasably connect the anchor to arch member coupling 24.

The base 32 of the anchor 30 can have a tooth facing surface contour that is customized to fit any suitable surface of a tooth 12. For example, in one or more embodiments, the base 32 has a tooth-facing surface contour that is customized to fit a lingual surface 13 of the tooth 12. Having a customized base 32 can allow the anchor 30 to be configured with a lower profile for patient comfort. In one or more embodiments, the base 32 of the anchor 30 can be customized such that it provides a self-positioning “lock and key” mechanism, where the base has contours that only allow anchor 30 to be mounted on the teeth 12 in a unique, well-defined location and orientation. Any suitable technique or combination of techniques can be utilized to form customized bondable anchors, e.g., the techniques described in U.S. Pat. No. 6,776,614 (Wiechmann et al.), U.S. Pat. No. 7,811,087 (Wiechmann et al.), and U.S. Pat. No. 7,850,451 (Wiechmann et al.), and U.S. Patent Publication No. 2005/0277084 (Cinader et al.). In one or more embodiments, the base 32 of one or more anchors 30 can include any suitably shaped surface that is not necessarily customized to fit a particular surface of a tooth, i.e., a “generic” base.

The anchor 30 can be attached to the surface 13 of tooth 12 using any suitable technique or combination of techniques. For example, the anchor 30 can be bonded to the surface 13 of tooth 12 using a suitable adhesive or cement. The anchor 30 need not be adhesively bonded. For example, one or more anchors 30 may be welded to an orthodontic band and the band subsequently secured to a respective tooth 12 using a suitable band cement. In one or more embodiments, anchors 30 are bondable lingual buttons or other commercially available off-the-shelf bondable appliances. Further, anchors 30 may be formed entirely from a curable composite dental material, such as TRANSBOND brand light cure adhesive (available from 3M Company, St. Paul, Minn.), and cured in vivo on the patient's teeth using techniques such as those described in U.S. Patent Application Publication No. 2007/0031774 (Cinader et al.).

Connected to one or more anchors is the arch member 20. In one or more embodiments, the arch member 20 can be a self-ligating arch member. The arch member 20 includes the arch member body 22 and one or more arch member couplings 24 connected to the body. In one or more embodiments, the arch member couplings 24 can be integral with the body 22. The arch member 20 can include any suitable number of arch member couplings 24, e.g., 1, 2, 3, 4, 5 or more couplings. The arch member coupling 24 can be connected to the arch member body 22 using any suitable technique or combination of techniques. In one or more embodiments, the arch member couplings 24 can be attached to the arch member body 22 using any suitable technique or combination of techniques, e.g., welding, adhering using an adhesive, etc. In one or more embodiments, the arch member couplings 24 can be integrally formed with the arch member body 22 such that the arch member couplings are integral with the arch member body 22.

In one or more embodiments, the arch member coupling 24 can be connected to the arch member body 22 such that the anchor 30 connected to the arch member coupling via anchor coupling 34 is adapted for displacement relative to the arch member body. In one or more embodiments, the anchor 30 is adapted for displacement relative to the arch member body 22 such that the anchor can slide relative to the arch member body. In one or more embodiments, the anchor 30 can slide along the arch member body 22. In one or more embodiments, the anchor 30 can move relative to the arch member body 22. In one or more embodiments, the arch member body can move relative to the anchor 30. In one or more embodiments, both the anchor 30 and the arch member body 22 can move relative to each other. For example, the arch member coupling 24 can include a recess 26 adapted to releasably engage a post 36 of anchor coupling 34 of anchor 30 (as shown in FIG. 2). In one or more embodiments, a resilient liner 29 can be disposed within the recess 26. The resilient liner 29 can be adapted to releasably engage the post 36 of the anchor coupling 34. The arch member coupling 24 can, in one or more embodiments, surround the anchor coupling 34 when connected.

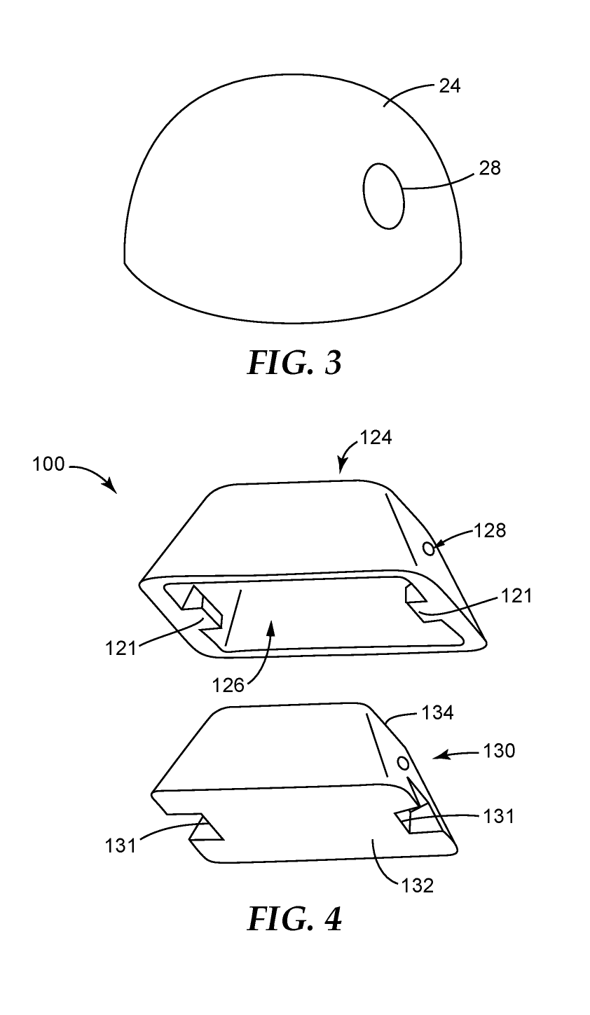

In one or more embodiments, the arch member couplings 24 can include a channel 28 formed through the coupling as shown in FIG. 3. The arch member body 22 can be disposed within the channel 28. In one or more embodiments, the arch member body 22 can move relative to the arch member coupling 24 within the channel 28 such that the body is slidably connected to the arch member coupling. The channel 28 can take any suitable cross-sectional shape or combination of shapes, e.g., the same cross-sectional shape as the portion of the arch member body 22 that is disposed within the channel. Further, the channel 28 can have any suitable dimensions. In one or more embodiments, the channel has a cross-sectional area that is greater than a cross-sectional area of a portion of the arch member body 22 that is disposed within the channel such that the arch member body can move or slide relative to the arch member coupling 24. In certain embodiments, the dimensions of the channel may be dictated by prescription or other treatment related constraints.

In one or more embodiments, the channel 28 can be formed through the arch member coupling 24 such that it extends along an axis that forms any suitable angle with the mesio-distal direction when the arch member coupling 24 is connected to the anchor coupling 34. Further, in one or more embodiments, the arch member coupling 24 can be connected to the anchor coupling 34 such that the axis of the channel 28 forms any suitable angle with the mesio-distal direction along the dental arch. By either forming or positioning the channel 28 at an angle relative to the mesio-distal direction, a selected corrective force (e.g., rotation, angulation, etc.) can be applied to the attached tooth.

The arch member couplings 24 can include any suitable material or combination materials. In one or more embodiments, the arch member couplings 24 can include the same material or combination of materials as those described for the arch member body 22. Each of the arch member couplings 24 can include the same material or combination of materials. In one or more embodiments, one or more arch member couplings 24 can include materials that are different from one or more additional arch member couplings 24.

The arch member couplings 24 can take any suitable shape or combination of shapes such that the arch member couplings are releasably connectable to one or more anchor couplings 34. Examples of releasable couplings are described, e.g., in issued U.S. Pat. No. 6,302,688 (Jordan et al.), U.S. Pat. No. 6,582,226 (Jordan et al.), U.S. Pat. No. 7,014,460 (Lai et al.), U.S. Pat. No. 7,252,505 (Lai), and U.S. Pat. No. 8,827,697 (Cinader et al.), and pending U.S. Patent Application Publication No. 2005/0277084 (Cinader et al.). In or more embodiments, the arch member coupling 24 and the anchor coupling 34 can each include a cross-sectional shape having two or more sides such that the appliance 10 can provide a force to correct angulation of one or more teeth. Although depicted as being connected to teeth via arch member couplings 24 and anchor couplings, in one or more embodiments, a portion of the arch member body 22 can be adapted to be attached directly to a surface 13 of a tooth 12 using any suitable technique or combination of techniques, e.g., direct bonding to the surface of the toot. The arch member coupling 24 can be releasably connected to the anchor coupling 34 using any suitable technique or combination of techniques. For example, the recess 26 of the arch member coupling 24 can be engaged with the post 36, and an adhesive can be applied to the arch member coupling and the anchor coupling to maintain the connection between the couplings. In one or more embodiments, a clamp, wire, or other device can be utilized to aid in maintaining the connection between the arch member coupling 24 and the anchor coupling 34.

The appliance 10 can be capable of producing various types of tooth movement. The configuration of the arch member body 22 and the anchor couplings 34 of anchors 30, and the displacement of the arch member body (e.g., by deformation of the arch member body) relative to the anchor can allow appliance 10 to move teeth in ways that can be difficult to achieve using conventional aligners and wire-embedded appliances. Because one or more portions of the arch member body 22 can be formed into a variety of configurations, the appliance 10 has the potential to produce any combination of in-out and mesial-distal tooth movements, as well as tipping and rotational tooth movements. Translational tooth movements parallel to the longitudinal axis of the arch member body 22 can be performed by incorporating one or more flexible springs into the arch member body or by forming one or more springs in the arch member body.

One or more anchors 30 can be adapted for displacement relative to the arch member body 22 when the anchor is connected to the surface of the tooth and the arch member coupling 24 is connected to the anchor coupling 34. For example, in the embodiment illustrated in FIGS. 1-3, the arch member body 22 is disposed within the channel 28 of the arch member coupling 24 such that it can move relative to the arch member coupling 24. When the arch member coupling 24 is releasably connected to the anchor coupling 34 of anchor 30, the arch member coupling and the anchor coupling remain relatively fixed. The arch member body 22, however, can, in one or more embodiments, be displaced relative to the anchor such that the arch member body slides within the channel 28, e.g., the anchor can slide relative to the arch member body. In one or more embodiments, this ability of the anchor 30 to move relative to the arch member body 22 can allow faster tooth movement during the initial stages of treatment because of the reduced friction between the arch member body 22 and the arch member coupling 24.

The arch member couplings 24 and the anchor couplings 34 can be adapted such that the arch member body 22 and one or more anchors 30 are in a fixed relationship when the arch member coupling is connected to the anchor coupling of the anchor. In other words, when the anchor coupling 34 and the arch member coupling 24 are connected, the arch member body 22 adjacent the arch member coupling 24 is fixed and cannot move relative to the anchor in a direction parallel to the surface 13 of the attached tooth 12, i.e., the arch member body cannot slide relative to the anchor.

The forces required to connect and disconnect couplings 24, 34 from each other can be sufficiently low to allow easy insertion and removal of the arch member 20 by the patient. In one or more embodiments, these forces can be sufficiently high such that the arch member 20 connects to the patient's dental structure and does not unintentionally detach from any of the anchors 30 during treatment. That is, couplings 24, 34 can remain connected even when subjected to normal corrective forces and other forces encountered during treatment. In one or more embodiments, couplings 24, 34 are adapted to yield an engagement force that is as low as possible. In one or more embodiments, the disengagement forces are neither too high such that disengagement causes patient discomfort nor too low such that spontaneous disengagement occurs during treatment. The optimal values for engagement and disengagement forces may vary considerably from tooth to tooth and depend in part on the configuration of the arch member body 22. In one or more embodiments, the forces required to disconnect couplings 24, 34 can be such that only a practitioner can remove the arch member 20.

The arch member 20 can provide a corrective force or forces to one or more teeth of a patient through the anchors 30 to provide an orthodontic treatment or series of treatments to the teeth of a patient. The arch member body 22 of the arch member 20 can include any suitable material or combination of materials that provide a wide range of material properties such as stiffness and resiliency. For example, the arch member body 22 can include metallic material, polymeric material, glass material, and combinations thereof. In one or more embodiments, the arch member body 22 can include at least one of nitinol, stainless steel, nickel titanium, and beta titanium. The arch member body 22 can be a unitary body or can include one or more layers of materials. Further, the arch member body 22 can be unitary along its length. In one or more embodiments, the arch member body 22 can include several portions that are connected together using any suitable technique or combination of techniques.

The arch member body 22 can also be individually configured based on the needs of the practitioner. For example, a given arch member body 22 can be made from stainless steel when a high level of corrective force is desired, nickel titanium for a lower level of force, and beta titanium for an intermediate level of force. In one or more embodiments, the body 22 can include other materials, including non-metallic materials such as polymers or filled composites. Furthermore, the cross-sectional geometry of the body 22 can be tailored to provide the desired corrective force or forces. For example, the shape and/or cross-sectional dimensions (e.g., thickness) of the body 22 can be tailored to provide the desired corrective force or forces. In one or more embodiments, the arch member body 22 can have a cross-sectional geometry that varies along a length of the body.

The arch member body 22 can include any suitable cross-sectional geometry, e.g., shape, area, orientation, etc. The cross-sectional geometry can be constant or vary along a length of the arch member body 22. For example, the arch member body 22 can take any suitable shape or combination of shapes. The arch member body 22 can also include any suitable cross-sectional shape, e.g., polygonal (e.g., triangular, rectangular, etc.), elliptical, etc. The cross-sectional shape of the arch member body 22 can be uniform along a length of the body. In one or more embodiments, a first portion of the arch member body 22 can have a first cross-sectional shape, and a second portion of the arch member body can have a second cross-sectional shape that is different from the first cross-sectional shape. The arch member body 22 can include a uniform cross-sectional area or a cross-sectional area that varies along the length of the body.

In one or more embodiments, the edges of the arch member body 22 can be smoothed after the body is formed to provide added comfort to a patient. Further, in one or more embodiments, one or more portions of the arch member body 22 can be coated with any suitable material or combination of materials to provide a coating that covers edges of the body to improve comfort. The arch member body 22 can also be covered with one or more protective covers that are applied to the body in portions between arch member couplings 24 such that the body does not have sharp corners but that the couplings can move relative to the body to provide a corrective force or forces to teeth of a patient. The covers can include any suitable material or combination of materials. In one or more embodiments, the covers can provide any desired aesthetic appearance. Further, the covers can include stain resistant material or materials to maintain the aesthetics of the covers.

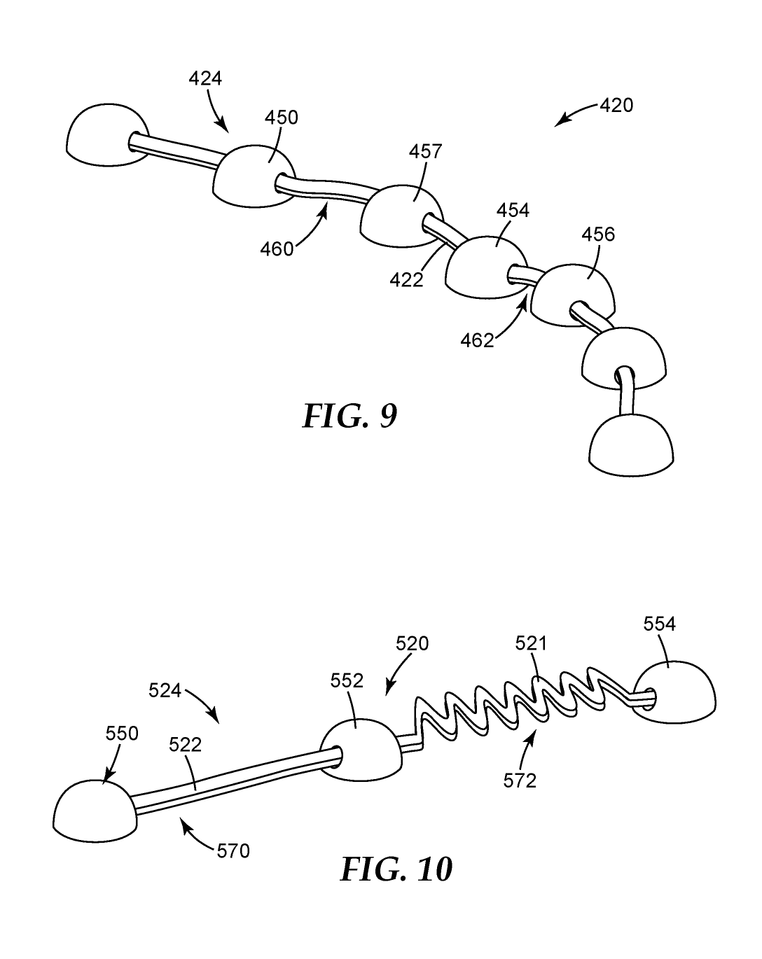

The arch member body 22 can be adapted to provide any suitable corrective force between two or more arch member couplings 24. Any suitable technique or combination of techniques can be utilized to provide these corrective forces. For example, FIG. 9 is a schematic perspective view of a portion of one embodiment of an arch member 420. All of the design considerations and possibilities regarding the arch member 20 of orthodontic appliance 10 of FIGS. 1-3 apply equally to the arch member 420 of FIG. 9. The arch member 420 includes an arch member body 422 and arch member couplings 424 connected to the body.

In one or more embodiments, a cross-sectional geometry (e.g., area) of the arch member body 422 can vary along a length of the body. For example, first portion 460 of arch member body 422, which is disposed between arch member coupling 450 and arch member coupling 452, has a first cross-sectional geometry. Arch member body 422 also includes a second portion 462, which is disposed between arch member coupling 454 and arch member coupling 456, has a second cross-sectional geometry. In one or more embodiments, the first cross-sectional geometry in first portion 460 is different from the second cross-sectional geometry in second portion 462. The cross-sectional geometry of the arch member body 422 can vary in any suitable plane or planes along the length of the body. In one or more embodiments, a thickness of the arch member body 422 can be varied to change the cross-sectional geometry of the body between any two anchor couplings 24 (a portion of that section of the body or continuously between). For example, in one or more embodiments, a thickness of the arch member body 422 can vary in a plane parallel to the mesio-distal direction and orthogonal to a surface of a tooth when the arch member 420 is connected to one or more teeth 12 of a patient via one or more anchors 30 as shown in FIG. 1. In one or more embodiments, a thickness of the arch member body 422 can vary in a plane orthogonal to the facial-lingual or occlusal-gingival directions along the mesial-distal length of the arch member and parallel to a surface of a tooth when the arch member 420 is connected to one or more teeth 12 of a patient via one or more anchors 30.

The cross-sectional geometry of the arch member body 422 can be selected to provide a desired bending stiffness in one or more portions of the arch member body. Tailoring the bending stiffness of the arch member body 422 can provide selected corrective forces that can be varied along a length of the arch member body. For example, in one or more embodiments, the second portion 462 of arch member body 422 can provide a smaller corrective force than the first portion 460 because the second portion has a cross-sectional area that is less than the cross-sectional area of the first portion. Although two portions 460, 462 of arch member body 422 are shown as having a varying cross-sectional geometry along the length of the body, any suitable portion or portions of the arch member body can have a varying cross-sectional geometry to provide one or more corrective forces between arch member couplings 424 of the arch member 420.

Although not shown in FIG. 9, the cross-sectional area of the arch member body 422 can also be varied along a portion or portions of the body that are connected to the arch member coupling 424. For example, the cross-sectional area of the arch member body 422 can be reduced in a portion connected to arch member coupling 450 such that portions of the body adjacent this portion have a greater cross-sectional area. The channel formed through arch member coupling 450 can be selected such that the coupling remains in position along the portion having a reduced cross-sectional area and cannot slide off of the arch member body because of the greater cross-section area of the portions of the arch member body adjacent the coupling. This variation in cross-sectional area can aid the practitioner in applying the arch member 420 to a patient's teeth by restricting the movement of one or more arch member couplings 224 along the length of the arch member body 422.

A shape of the arch member body can be varied in any suitable plane to provide one or more corrective forces between arch member couplings of the arch member. The arch member body can take any suitable shape or combination of shapes. For example, FIG. 10 is a schematic perspective view of a portion of another embodiment of an arch member 520. All of the design considerations and possibilities regarding arch member 20 of FIGS. 1-3 and arch member 420 of FIG. 9 apply equally to arch member 520 of FIG. 10. Arch member 520 includes arch member body 522 and arch member couplings 524 connected to the arch member body. The arch member body 522 includes a first nonlinear portion 570 between arch member couplings 550 and 552. Further, arch member body 522 includes a second nonlinear portion 572 between arch member couplings 552 and 554. The first nonlinear portion 570 can take a first shape that is the same as a second shape of the second nonlinear portion 572. In one or more embodiments, the first shape can be different from the second shape. Any suitable shape or combination of shapes can be formed in the arch member body 522. In one or more embodiments, at least one of the first and second nonlinear portions 570, 572 can be, e.g., U-shaped, V-shaped, S-shaped, sinusoidal, etc. For example, the first nonlinear portion 150 can take a sinusoidal shape that extends in at least one of the gingival, occlusal, mesial, and distal directions when the arch member 120 is connected to one or more teeth via anchors (e.g., anchors 30 of FIGS. 1-3).

The first nonlinear portion 570 and the second nonlinear portion 572 can extend in any direction or combination of directions. For example, in one or more embodiments, at least one of the first nonlinear portion 570 and the second nonlinear portion 572 can extend in at least one of a gingival, occlusal, labial, and lingual direction when the first and second anchors (e.g., anchors 40, 42 of FIG. 1) are connected to the surfaces (e.g., surfaces 15, 17) of the first and second teeth (e.g., first and second teeth 14, 16) and the first arch member coupling 550 and the second arch member coupling 552 are connected to the anchor coupling of the first anchor and the anchor coupling of the second anchor respectively.

In one or more embodiments, the shape of the arch member body 522 can vary in a plane parallel to the mesio-distal direction and orthogonal to a surface of a tooth when the arch member 520 is connected to an anchor coupling of one or more anchors (not shown) that are connected to one or more teeth. In one or more embodiments, the shape of the arch member body 522 can vary in a plane orthogonal to the mesio-distal direction and parallel to a surface of the tooth. In one or more embodiments, the second nonlinear portion 572 can include an arcuate portion, e.g., a sinusoidal portion such as spring 521. Any suitable spring or combination of springs can be utilized. The spring 521 can be installed in a patient's mouth such that it is either in tension or compression to provide the desired corrective force.

In one or more embodiments, the first nonlinear portion 570 can have a first shape that is adapted to provide a first corrective force to one or both teeth connected to arch member couplings 550 and 552. Further, the second nonlinear portion 572 can have a second shape that is adapted to provide a second corrective force to one or both teeth that are attached to arch member couplings 550 and 552. The first corrective force can be the same as the second corrective force. In one or more embodiments, the first corrective force is different from the second corrective force.

One or more portions of the arch member body 522 can include both a varying cross-sectional geometry and a nonlinear shape or shapes. For example, second nonlinear portion 572 can also include a cross-sectional geometry that varies along the length of the portion, e.g., a thickness of the portion can vary along the spring 521.

Returning to FIGS. 1-3, the arch member body 22 can include one or more nonlinear portions 56, 58, 60 between arch member couplings. One or more of the nonlinear portions, e.g., nonlinear portions 56, 58 can be adapted to be spaced apart from the surfaces 15, 17 of teeth that are connected to the appliance 10 by anchors 30. For example, as shown in FIG. 1, the first nonlinear portion 56 of the arch member body 22, which is between the first arch member coupling 50 and the second arch member coupling 52, can be adapted to be spaced apart from the surfaces 15, 17 of the first tooth 14 and the second tooth 16 when the first and second anchors 40, 42 are connected to the surfaces of the first and second teeth and the first and second arch member couplings 50, 52 are releasably connected to the anchor couplings of the first and second anchors 40, 42. The first nonlinear portion 56 can be spaced apart from the surfaces 15, 17 of the first and second teeth 14, 16 any suitable distance. The first nonlinear portion 56 can be spaced apart the same distance from each of the surfaces 15, 17 of the first and second teeth 14, 16. In one or more embodiments, the first nonlinear portion 56 can be spaced apart a distance from the surface 15 of the first tooth 14 that is different from the distance between the first nonlinear portion and the surface 17 of the second tooth 16. Any suitable number of portions of the arch member body 22 can be spaced apart from surfaces of the teeth to which the appliance 10 is connected. In one or more embodiments, the entire arch member body 22 is spaced apart from the connected surfaces of the teeth 12. In one or more embodiments, one or more portions of the arch member body 22 can be in contact with one or more teeth while one or more additional portions of the arch member body can be spaced apart from additional teeth.

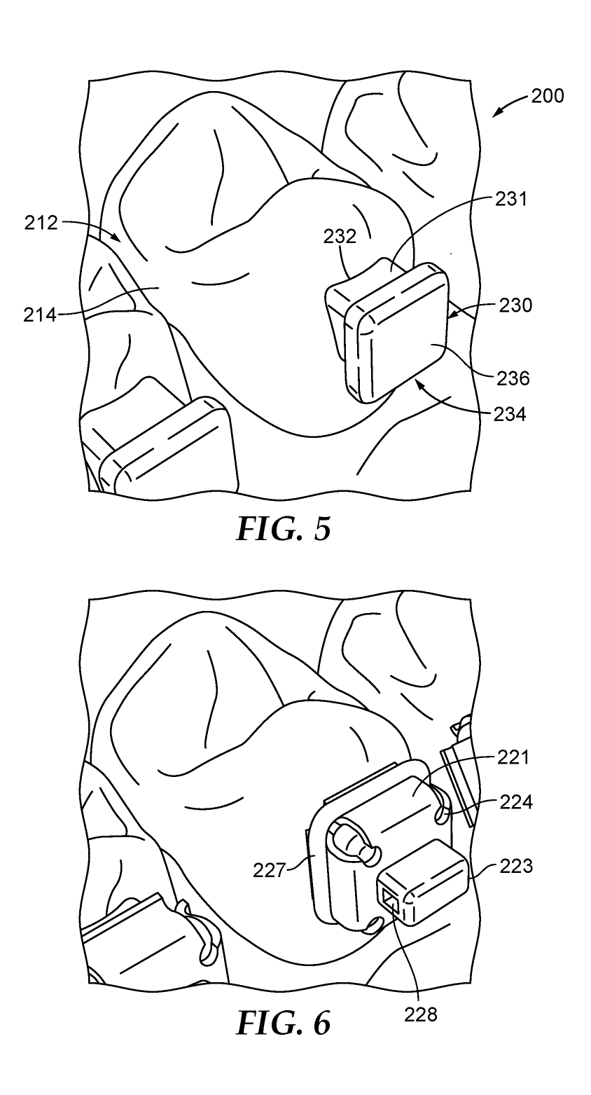

One or both of the arch member 20 and the anchors 30 can include other devices or elements that can be utilized to provide a selected treatment to a patient. For example, in one or more embodiments, the selected shape of a nonlinear portion between two arch member couplings 24 can include at least one of a hook, a twist, a step, a loop, and a spring. For example, the arch member body 22 can include one or more flexible springs (e.g., spring 521 of FIG. 5) that allows longitudinal movement (i.e., in a direction generally along the length of the arch member body). The spring can be integral to the arch member body 22 or made separately from the body and connected to the body using any suitable technique or combination of techniques. The spring can also increase the flexibility of the arch member body 22. In one or more embodiments, the spring can be resilient and can deliver tensile or compressive forces in the longitudinal direction. Various types of springs may be used, including Z-springs, coil springs, omega loops, pushrods, or any combinations thereof. By increasing flexibility of the arch member body 22 and allowing longitudinal deflection, the springs can facilitate connecting the arch member couplings 24 and the anchor couplings 34 when the teeth are maloccluded. Based on the patient's treatment plan, the springs may be provided along any suitable portion or portions of the arch member body 22. The arch member 20 can include one or more tangs that can be adapted to engage at least one of the anchors 30 to maintain a connection between the arch member coupling 24 and the anchor coupling 34.

The arch member body 22 can be manufactured using any suitable technique or combination of techniques. In one or more embodiments, the arch member body 22 can be formed from a substrate, e.g., a sheet of material, by removing a portion or portions of the substrate. For example, a nitinol substrate can be cut or etched to form the arch member body 22. Any suitable technique or combination of techniques can be utilized to cut or etch the substrate, e.g., laser cutting, water jet cutting, etching (e.g., ion beam etching), die cutting, etc.

The arch member body 22 can be formed into any suitable shape or combination of shapes using any suitable technique or combinations of techniques. For example, the shape of the arch member body 22 can be formed when the arch member is cut or etched from a substrate. In one or more embodiments, the arch member body 22 can be formed and then shaped into one or more shapes using any suitable technique or combination of techniques, e.g., bending, machining, etc. The one or more shapes of the arch member body 22 can be set using any suitable technique or combination of techniques, e.g., heat setting.

As mentioned herein, the arch member body 22 can have any suitable cross-sectional geometry along the length of the body. In one or more embodiments, the arch member body 22 can have a thickness in an occlusal direction that varies along a length of the arch member body 22 when the arch member body is connected to one or more anchors 30 of the appliance 10. Varying the thickness of the arch member body 22 can provide control of corrective forces that are applied to one or more teeth. This thickness can be varied using any suitable technique or combination of techniques. In one or more embodiments, the thickness can be varied by removing portions of the arch member body 22 by ablating, etching, sanding, cutting, etc. The arch member body 22 can also be elongated in one or more portions to reduce the thickness in such portions.

The orthodontic appliance 10 can be manufactured using any suitable technique or combination of techniques. For example, in one or more embodiments, one or both of the arch member 20 and the anchor 30 can be manufactured using rapid manufacturing techniques. In one or more embodiments, the anchor coupling 34 and the arch member coupling 24 can be chosen from a standard library either by the manufacturer or a practitioner. Similarly, the arch member body 22 can be selected from a standard library and modified to meet the treatment targets of the practitioner. The tooth position targets for each stage of treatment can be suggested by software or by a technician and modified by the practitioner as necessary. During treatment, one or more of the tooth position targets can be generated from the information contained in an intermediate scan of the teeth, e.g., as described in co-owned U.S. Patent Application Publication No. 2010/0260405 (Cinader et al.). Subsequent appliances can be produced on an as-needed basis rather than producing the entire series of appliances at the outset of treatment. In one or more embodiments, the practitioner can fabricate the appliance entirely in the practitioner's office. This can give the practitioner more flexibility to adjust the appliance as the treatment progresses.

In one or more embodiments, one or both of the arch member 20 and the anchor 30 can be manufactured using 3D printing technology. For example, one or more data files can be selected by a practitioner that can then produce the orthodontic appliance 10 using 3D printing technology.

The arch member coupling 24 and the anchor coupling 34 can be designed in any suitable manner such that the arch member coupling is releasably connectable to the anchor coupling. For example, FIG. 4 is a schematic perspective view of an anchor 130 and an arch member coupling 124. The anchor 130 and the arch member coupling 124 can be a part of any suitable orthodontic appliance, e.g., appliance 10 of FIGS. 1-3. The anchor 130 can include an anchor coupling 134 and a base 132. The base 132 is adapted to connect the anchor to a surface of a tooth. The arch member coupling 124 is releasably connectable to the anchor coupling 134. For example, the arch member coupling 124 includes one or more tabs 121 disposed within a recess 126. Further, the anchor 130 includes one or more slots 131 adapted to receive the tabs 121 of the arch member coupling 124 such that the arch member coupling is releasably connectable to the anchor 130. In one or more embodiments, the arch member coupling 124 can include a resilient material that expands as the tabs 121 engage the slots 131 of anchor coupling 134. When connected, the arch member coupling 124 surrounds the anchor coupling 134.

In one or more embodiments, the arch member coupling 124 includes a channel 128 adapted such that a portion of an arch member body can be disposed within the channel. In one or more embodiments, the arch member body can be slidably disposed within the channel 128 such that the anchor 130 can be displaced relative to the arch member body when the arch member coupling is connected to the anchor coupling 134. To allow for this displacement, the arch member coupling 124 can be sized such that a space is provided between the anchor coupling 134 and an inner surface of the recess 126 adjacent the channel 128 such that the anchor coupling 134 does not interfere with the displacement of the arch member body when the body is disposed within the channel 128. In one or more embodiments, both the arch member coupling 124 and the anchor coupling 134 can include channels 128, 138 such that a portion of the arch member body can be disposed within the channels of the arch member coupling and the anchor coupling. In such embodiments, the arch member body can be disposed within the channel 128, 138 of the arch member coupling 124 and the anchor coupling 134 after the arch member coupling and the anchor coupling are connected.

FIGS. 5-6 are schematic perspective views of a portion of another embodiment of an orthodontic appliance 200. All of the design considerations and possibilities regarding the orthodontic appliance 10 of FIGS. 1-3 apply equally to the orthodontic appliance 200 of FIGS. 5-6. Orthodontic appliance 200 includes an arch member 220 that includes an arch member body (not shown for clarity) and an arch member coupling 224 connected to the body. The appliance 200 also includes an anchor 230 that includes an anchor coupling 234 and a base 232 adapted to connect the anchor to a surface 214 of a tooth 212. In one or more embodiments, the arch member coupling 224 is releasably connectable to the anchor coupling 234. Further, in one or more embodiments, the anchor 230 is adapted for displacement relative to the arch member body when the anchor 230 is connected to the surface 214 of the tooth 212 and the arch member coupling 224 is connected to the anchor coupling 234.

The anchor 230 can include an anchor coupling 234 in the form of a post 236. The post 236 includes a slot or undercut portion 231. The slot 231 can take any suitable shape or combination of shapes. In the embodiment illustrated in FIGS. 5-6, the slot 231 is formed in each of the sides of the post 236. In one or more embodiments, the slot 231 can be formed in 1, 2, 3, 4 or any number of sides of the post 236. In one or more embodiments where the post 236 includes an elliptical cross section, the slot 231 can be formed along the elliptical surface of the post 236.

Further, the arch member coupling 224 includes one or more tabs 221. The arch member coupling 224 can include any suitable number of tabs 221. In one or more embodiments, the tabs 221 can be resilient. For example, the tabs 221 can include one or more wires similar to those used in snaps for clothing articles that deflect when the arch member coupling 224 engages the anchor coupling 234. The slots 231 of the anchor coupling 234 can be adapted to receive the tabs 221 of the arch member coupling 224 such that the anchor coupling 232 is snap-fit to the arch member coupling. The arch member coupling 224 can also include a channel 228 that is adapted to receive a portion of an arch member body (not shown).

In one or more embodiments, the anchor 230 is adapted for displacement relative to the arch member body when the anchor is connected to a surface 214 of a tooth 214 and the arch member coupling 224 is connected to the anchor coupling 234. For example, a portion of the arch member body can be disposed within the channel 228 such that the arch member body can slide relative to the anchor 230. In one or more embodiments, the channel 228 can be formed in a channel body 223 of the arch member coupling 224. The channel body 223 can be attached to the resilient tabs 221. Any suitable technique or combination of techniques can be utilized to attach the channel body 223 to the tabs 221. In one or more embodiments, the channel body 223 can be integral with the tabs 221 to form a unitary arch member coupling 224.

The channel body 223 can be adapted to provide any desired corrective force to one or more teeth in combination with a deformation of the arch member body 22, e.g., torque, angulation, rotation, etc. For example, the channel body 223 can be formed with the anchor 230 or attached to the anchor such that the channel 223 extends along an axis that forms an angle with the mesio-distal direction in a plane orthogonal to the surface 14. By forming this angle, a rotational corrective force can be provided to the attached tooth 212 to correct for rotation of the tooth.

The appliance 200 can also include a clamp 227 that is adapted to engage one or more of the tabs 221 of the arch member coupling 224 to assist in maintaining the connection between the arch member coupling and the anchor coupling 234. The clamp 227 can include any suitable material or combination of materials and take any suitable shape. In one or more embodiments, the clamp 227 can be a resilient o-ring that can be slid over an outer surface of the arch member coupling 224 and engage the tabs 221 such that the tabs remain engaged with the slots 231 of the anchor 230.

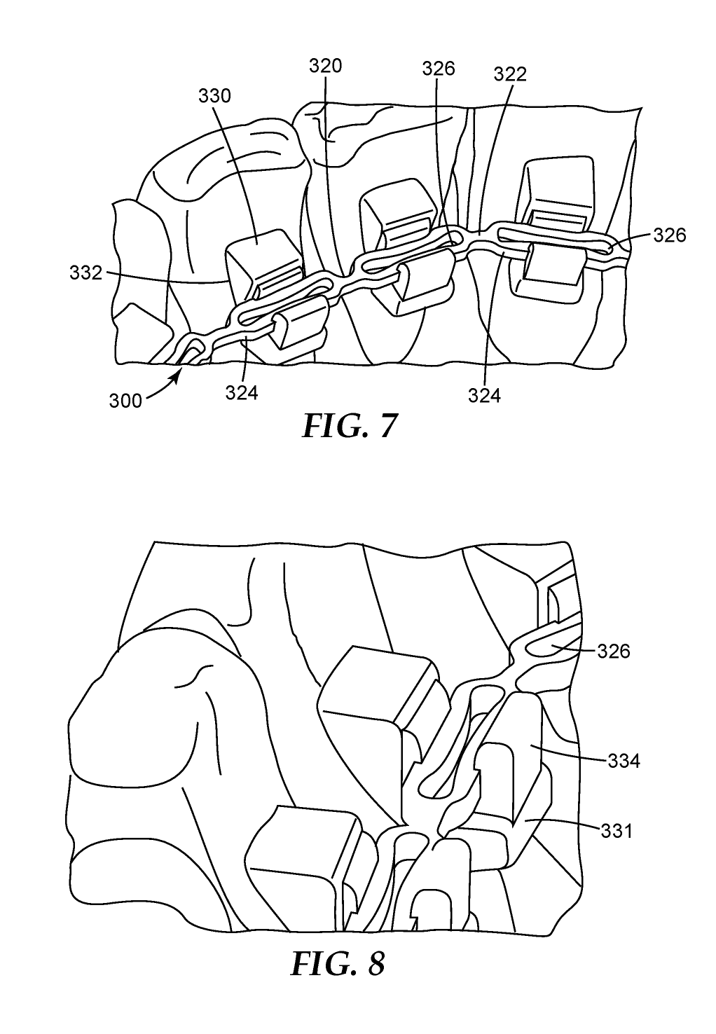

FIGS. 7-8 are schematic perspective views of a portion of another embodiment of an orthodontic appliance 300. All of the design considerations and possibilities regarding the orthodontic appliance 10 of FIGS. 1-3 apply equally to the appliance 300 of FIGS. 7-8. The appliance 300 includes arch member 320 that includes an arch member body 322 and one or more arch member couplings 324 connected to the body. One or more arch member couplings 224 can include a slotted portion 326 of the arch member body 322. The slotted portion 326 can take any suitable shape or combination of shapes and can be any suitable dimensions. In one or more embodiments, the slotted portion 326 can be formed using any suitable technique or combination of techniques. For example, in one or more embodiments, the slotted portion 326 can be formed when the arch member body 322 is formed using any suitable technique or combination of techniques. In one or more embodiments, the slotted portion 326 can be formed after the arch member body 322 is formed, e.g., the arch member body can be cut or etched to form the slotted portion. In one or more embodiments, the slotted portion 326 is resilient.

The appliance 300 also includes one or more anchors 330 that can each include an anchor coupling 334 and a base 332 adapted to connect the anchor to a surface 314 of a tooth 312. One or more anchor couplings 334 can include a slot 331 adapted to receive the slotted portion 326 of the arch member body 322. In one or more embodiments, the slot 331 of the anchor coupling 334 can include an undercut portion or portions that retain the slotted portion 326 of the arch member body 322 within the slot 331. The slot 331 can include any suitable dimensions and take any suitable shape or combination of shapes. In one or more embodiments, the slot 331 can have a width in a direction orthogonal to a surface 314 of a tooth 312 that is smaller than a width of the slotted portion 326 of the arch member body 322 such that the slotted portion is friction-fit within the slot. The arch member 320 can be connected to the anchor 330 by pressing the arch member down into the slot 331 in a gingival direction. In one or more embodiments, the slot 331 can be disposed such that its width is substantially parallel with the surface 314 of the tooth 312 to which the anchor 330 is attached such that the arch member 320 can be connected to the anchor by pressing the arch member into the slot 331 in a distal direction. Further, the slot 331 can be formed in the anchor 330 or manufactured separately and attached to the base 332 of the anchor.

In one or more embodiments, the arch member coupling 324 is releasably connectable to the anchor coupling 334. Further, in one or more embodiments, the slot 331 of the anchor coupling 334 and the slotted portion 326 of the arch member body 322 are adapted such that the slotted portion can move relative to the slot. In such embodiments, the anchor 330 is, therefore, adapted for displacement relative to the arch member body 322 when the anchor is connected to the surface 314 of the tooth 312 and the arch member coupling 324 is connected to the anchor coupling 334. In one or more embodiments, the slot 331 and the arch member body 322 are adapted such that the slotted portion 326 of the arch member body can move in a direction substantially parallel to a length of the slot, e.g., in a direction substantially parallel to the surface 314 of the tooth 312. In one or more embodiments, the slot 331 of the anchor coupling 334 and the slotted portion 326 of the arch member body 322 are adapted such that the arch member body can move in a mesio-distal direction relative to the anchor 330.

In general, the various embodiments of arch members and anchors can be used interchangeably to provide selected treatments. For example, in one exemplary embodiment, one or more teeth of a patient may be connected to anchors 330 of appliance 300 illustrated in FIGS. 8-9, with the anchors coupled to an arch member that includes arch member couplings 324, and one or more additional teeth may be connected to anchors 30 of the appliance 10 illustrated in FIGS. 1-3, with the anchors coupled to one or more arch member couplings 24. In one or more embodiments, different embodiments of appliances can be used for different phases of treatment. For example, the appliance 300 of FIGS. 8-9 may be utilized in an early treatment phase, and the appliance 10 of FIGS. 1-3 may be utilized in a later treatment phase of the same patient.

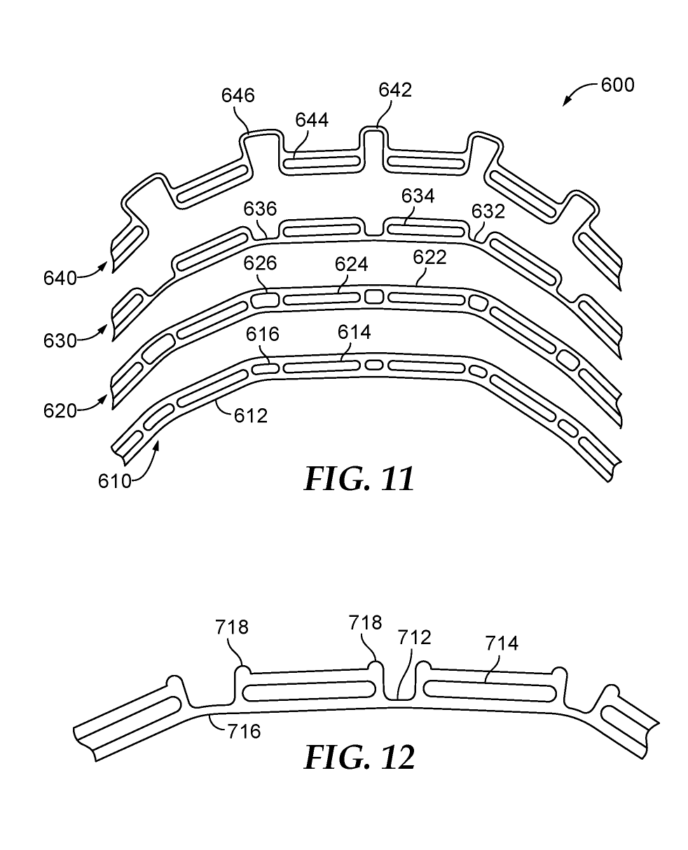

Any suitable technique or combination of techniques can be utilized to provide selected corrective forces to one or more teeth of a patient. For example, FIG. 11 is a schematic plan view of a set of arch members 600. All of the design considerations and possibilities regarding the arch member 20 of FIGS. 1-4 apply equally to each of the arch members of the set of arch member 600 of FIG. 11. The set of arch members 600 can be utilized with any suitable orthodontic appliance, e.g., orthodontic appliance 10 of FIG. 1-4. First arch member 610 includes arch member body 612, arch member couplings 614, and one or more openings 616 that are disposed in the arch member body. Each opening 616 disposed in the arch member body 612 can take any suitable shape and include any suitable dimensions. In one or more embodiments, an opening 616 can be disposed between each pair of arch member couplings 614. In one or more embodiments, one or more portions between a pair of arch member couplings 614 can be continuous such that the portion does not include an opening.

In general, the shape and size of each opening 616 can be selected to provide the desired corrective force to teeth that are coupled to the arch member 610. By forming various shapes and sizes of openings 616, the corrective force can be tailored. For example, in one or more embodiments, an opening 616 having a larger cross-sectional area can provide a corrective force to attached teeth that is less than a corrective force of the arch member 610 in a portion having an opening that has a smaller cross-sectional area.

The one or more openings disposed in the arch member can take any suitable shape and have any suitable dimensions. For example, arch member 620 includes openings 626 that are disposed in arch member body 622 and have a larger cross-sectional area than openings 616 of arch member 610. Arch member 620, therefore, can provide corrective forces to attached teeth that are less than corrective forces provided by arch member 610. In one or more embodiments, the treatment of a patient may begin with arch member 610 and progress to arch member 620 as less corrective force is required as the teeth are moved closer to a target position.

In one or more embodiments, the treatment can progress to arch member 630, which includes portions 636 of arch member body 632 that have a cross-sectional area that is less than the cross-sectional area of the portions of arch member body 622 of arch member 620 that include openings 626. In one or more embodiments, a smaller cross-sectional area of the arch member body 632 can provide a corrective force between arch member couplings 634 that is less than the corrective force provided by the portions of arch member body 622 of arch member 620 that includes openings 626. Portion 636 can have any suitable shape or combination of shapes. For example, as mentioned herein, portion 636 can have a nonlinear shape that is selected to provide a desired corrective force to teeth that are connected to the arch member body 632 by arch member couplings 634 and anchors (e.g., anchors 30 of appliance 10 of FIGS. 1-4).

Depending upon the desired treatment program, the set of arch members 600 can include a fourth arch member 640 that includes arch member body 642, arch member couplings 644, and portions 646 between the arch member couplings. Portions 646 can include any suitable shape and include any suitable cross-sectional geometry to provide a desired corrective force or forces to teeth that are connected to the arch member body 640. As shown in FIG. 11, portions 646 are U-shaped and can provide a desired corrective force. In one or more embodiments, the U-shaped portions 646 can provide a corrective force that is in general smaller than the corrective force provided by portions 636 of arch member 630.

The various arch members described herein can include other features that provide various functionalities to orthodontic appliances. For example, FIG. 12 is a schematic plan view of an arch member 710. All of the design considerations and possibilities regarding arch member 20 of FIGS. 1-4 apply equally to arch member 710 of FIG. 12. Arch member 710 includes arch member body 712, one or more arch member couplings 714 connected to the body, and portions 716 disposed in the arch member body. Arch member 710 also includes protuberances 718 disposed in the arch member body 712. In one or more embodiments, each arch member coupling 714 can include 2 protuberances 718 that engage an anchor (e.g., anchor 30 of FIGS. 1-4) and prevent the arch member from sliding within the anchor beyond a selected distance. The protuberances 718, therefore, can prevent or limit mesio-distal travel along the arch member 710.

The various embodiments of orthodontic appliances of the present disclosure can be utilized with any suitable orthodontic treatment system. For example, in one or more embodiments, an orthodontic treatment system can include an orthodontic appliance, e.g., orthodontic appliance 10. The orthodontic appliance can include a set of arch members (e.g., arch member 20 of FIGS. 1-3). Each arch member 20 can include an arch member body 22 and an arch member coupling 24 connected to the body. The appliance can also include a set of anchors (e.g., anchor 30 of FIGS. 1-3) that are adapted to connect to respective teeth of a patient's dental arch. Each anchor 30 can include an anchor coupling 34 and a base 32 adapted to connect the anchor to a surface of the tooth. Each arch member coupling 24 can be releasably connectable to the anchor coupling 34 of the anchor 30 of the set of anchors. Further, the anchor of the set of anchors can be adapted for displacement relative to the arch member body when the anchor is connected to the surface of the tooth and the arch member coupling is connected to the anchor coupling.

In one or more embodiments, a first arch member of the set of arch members can have a geometry (e.g., shape, cross-sectional geometry, etc.) selected to move at least one tooth from a first arrangement to a second arrangement. Further, in one or more embodiments, a second arch member of the set of arch members can have a geometry (e.g., shape, cross-sectional geometry, etc.) selected to move at least one tooth from the second arrangement to a third arrangement.

The various embodiments of orthodontic appliances described herein can be utilized with any suitable additional appliances. For example in one or more embodiments, orthodontic appliance 10 of FIGS. 1-3 can be utilized with one or more brackets, buccal tubes, bands, cleats, buttons, removable appliances (including aligner trays), palatal expanders, and combinations thereof. One or more additional appliances can be adapted to be connected to an orthodontic appliance (e.g., appliance 10 of FIGS. 1-3). For example, a palatal expander can be adapted to be connected to an orthodontic appliance using any technique or combination of techniques. In one or more embodiments, one or more additional appliances can be used simultaneously with one or more appliances but not be connected to such appliance.

The various embodiments of orthodontic appliances described herein can be manufactured using any suitable technique or combination of techniques, e.g., the techniques described in U.S. Patent Application Publication No. 2010/0260405 (Cinader, Jr.) and U.S. Provisional Patent Application Ser. No. 62/097,733 (Atty. Docket No. 75174US002). In reference to orthodontic appliance 10 of FIGS. 1-3, one exemplary technique includes providing a physical dental model of a patient's teeth that can be used to form the appliance 10. The configuration of the dental model can represent a target dental arrangement as perceived by the treating professional. As defined herein, the “target dental arrangement” may be a patient's current dental arrangement, a desired final dental arrangement, or a predicted intermediate dental arrangement, depending on the application contemplated by the treating professional. In one or more embodiments, the target dental arrangement can also include a desired arrangement of one or more anchor couplings.

If the target dental arrangement is defined as the patient's current dental arrangement, then the dental model can be provided, for example, from an epoxy resin or stone casting prepared from an alginate, polyvinylsiloxane, or polyether impression of a patient's dentition. If the target dental arrangement is defined as an intermediate or final dental arrangement, then this casting may be sectioned into individual model tooth elements, and the tooth elements can be rearranged to form the desired dental arrangement. Further, the tooth elements can be waxed back together to provide the dental model. In one or more embodiments, the dental model can also be a reconfigurable dental model, thereby allowing individual teeth to be rearranged without sectioning. Examples of reconfigurable dental models are described, e.g., in U.S. Pat. No. 6,227,851 (Chishti et al.) and U.S. Pat. No. 6,394,801 (Chishti et al.).

The dental model can be used as a template to make and configure the orthodontic appliance 10. The anchors 30 can be connected to the respective lingual and/or labial tooth surfaces of the dental model. The arch member 20 can be formed into a desired configuration using any suitable technique or combination of techniques such that the arch member couplings 24 are releasably connectable to the anchor couplings 34 of anchors 30. In one or more embodiments, the arch member body 22 can be formed by extrusion and then shaped using known techniques. In one or more embodiments, the arch member body 22 can be formed by cutting, stamping, or etching a substrate. In one or more embodiments, a polymeric material can be thermoformed or cast to provide an arch member body 22, and one or more arch member couplings 24 can be connected to the arch member body. In one or more embodiments, the arch member body 22 can be formed using 3D printing techniques.

Once the arch member body 22 is formed, the arch member couplings 24 can be disposed along the arch member body such that the arch member couplings are connected to the arch member body. In one or more embodiments where the arch member couplings 24 are formed along with the arch member body 22 (e.g., arch member body 320 of FIGS. 7-8), the arch member couplings can be formed by slitting or etching one or more slots in the arch member body. In one or more embodiments, the slots can be disposed in the arch member body 22 during thermoforming or casting of the arch member 20.

To use the appliance 10, the anchors 30 are transferred from the dental model to the patient's teeth. To preserve the precise locations of the anchors 30 relative to the respective teeth, an indirect bonding tray or other transfer apparatus can be utilized. If the anchors 30 are customized to the lingual surfaces of the patient's teeth and thereby self-positioning, direct bonding may be a viable alternative. The arch member 20 can be placed in the patient's mouth and releasably connected to the anchors 30 via the arch member couplings 24.

By performing operations in a virtual world, it is also possible for one or more of these steps to be consolidated or even eliminated. Various digital techniques can potentially improve the precision of appliance design and facilitate aspects of the fabrication process that are traditionally done by hand.

One exemplary technique is digital scanning. A virtual dental model representing the patient's dental structure can be captured using a digital intraoral scan or by digitally scanning an impression or dental model. The digital images may be provided using a hand-held intra-oral scanner such as the intra-oral scanner using active wavefront sampling developed by Brontes Technologies, Inc. (Lexington, Mass.) and described, e.g., in PCT Publication No. WO 2007/084727 (Boerjes et al.). In one or more embodiments, other intra-oral scanners or intra-oral contact probes may be used. As another option, the digital structure data may be provided by scanning a negative impression of the patient's teeth. As still another option, the digital structure data may be provided by imaging a positive physical model of the patient's teeth or by using a contact probe on a model of the patient's teeth. The model used for scanning may be made, for example, by casting an impression of a patient's dentition from a suitable impression material such as alginate or polyvinylsiloxane (PVS), pouring a casting material (such as orthodontic stone or epoxy resin) into the impression, and allowing the casting material to cure. Any suitable scanning technique may be used for scanning the model, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader et al.).

From there, it is possible for a treating professional to manipulate the virtual dental model on a computer, for example, to arrive at the target dental arrangement. Further details on software and processes that may be used to derive the target dental arrangement are disclosed, e.g., in U.S. Pat. No. 6,739,870 (Lai et al.), U.S. Pat. No. 8,194,067 (Raby et al.), U.S. Pat. No. 7,291,011 (Stark et al.), U.S. Pat. No. 7,354,268 (Raby et al.), U.S. Pat. No. 7,869,983 (Raby et al.) and U.S. Pat. No. 7,726,968 (Raby et al.).

Another digital technique that can facilitate preparation of the dental model is rapid prototyping. After a virtual dental model has been created using any of the above techniques, rapid prototyping techniques can allow the dental model to be directly fabricated from this virtual dental model. Advantageously, there is no need to take an alginate impression or cast a stone model. Examples of rapid prototyping techniques include, but are not limited to, three-dimensional (3D) printing, selective area laser deposition or selective laser sintering (SLS), electrophoretic deposition, robocasting, fused deposition modeling (FDM), laminated object manufacturing (LOM), stereolithography (SLA) and photostereolithography. These and other methods of forming a positive dental model from scanned digital data are disclosed, e.g., in U.S. Pat. No. 8,535,580 (Cinader).

In one or more embodiments, the anchors 30 can be connected to the patient's teeth prior to taking an impression or intraoral scan. Since the anchors 30 can be directly bonded to the patient's teeth, this can simplify the process by eliminating the need to bond the anchors to the physical dental model, as well as the need to transfer the anchors to the patient's teeth. As before, the manipulation of the dental model from the maloccluded dental arrangement to the target dental arrangement may be carried out on a computer. There are other potential benefits. For example, if the anchors 30 and the patient's teeth are captured together in an intraoral scan, it is possible to digitally configure arch member 20 using a wire bending apparatus or robot based on the relative locations of the anchors and the patient's teeth.

Rapid prototyping may even eliminate the need to provide a physical dental model for fabricating the appliance 10. While it has been shown that rapid prototyping can be used to fabricate a dental model, it is also conceivable that rapid prototyping could be used to directly fabricate at least a portion of the appliance 10. The configuration of the arch member body 22, the anchors 30, and the couplings 24, 34 can be carried out with the assistance of rapid prototyping techniques. Direct fabrication can provide potential cost and time savings by eliminating intermediate steps in the fabrication of the appliance 10.

If the appliance 10 is directly fabricated from a virtual dental model, a physical dental model may still be useful to verify the appliance for quality control purposes. This may be carried out by seating the arch member 20 against a physical dental model and observing that each arch member coupling 24 releasably connects to a respective anchor 30. Assuming that the appliance 10 is properly configured and the dental model represents the target dental arrangement, the arch member 20 should be relaxed when releasably connected to the anchors 30. This procedure can also be used to verify the appliance 10 on a dental model representing a maloccluded (or non-desired) dental arrangement to ensure that the arch member couplings 24 of the arch member 20 can properly connect to the corresponding anchor couplings 34 anchors 30. In this case, the appliance 10 is active, so one or more portions of the arch member body 22 should be acting in force-transmitting engagement upon releasably connecting the arch member 20 to the anchors 30.

In one or more embodiments, the arch member 20 of the appliance 10 can be reconfigured during the course of treatment. Reconfiguring the arch member 20 and, in one or more embodiments, one or more anchors 30, can be an efficient and cost-effective alternative to fabricating a series of arch members. For example, the arch member 20 may be reconfigured to guide teeth through two or more dental arrangements during the course of treatment by making manual adjustments (e.g., bends) to one or more portions of the arch member body 22. This can also be used advantageously to re-activate the appliance 10. For example, if the patient's teeth have moved to an extent that the current appliance 10 is no longer exerting sufficient corrective force to effect tooth movement, the treating professional has the freedom to restore the corrective forces applied by the appliance by making appropriate adjustments to the arch member body 22. In one or more embodiments, such adjustments can also be made to overcorrect or compensate for anticipated relapse of one or more teeth. Optionally, the locations of the anchors 30 are captured beforehand using an intraoral scan or other scanning technique, and this information can be used to configure the arch member body 22 automatically using a wire bending apparatus or robot.

In one or more embodiments, a series of two or more arch members 20 can be formed to provide a progressive treatment that applies selected corrective forces to one or more teeth such that the teeth are repositioned from an initial maloccluded position to a final target position through, for at least one or more teeth, one or more intermediate positions.

The various embodiments of orthodontic appliances described herein can be utilized in any suitable application. In one application, an appliance (e.g., orthodontic appliance 10 of FIGS. 1-3) functions as a retainer that maintains the patient's teeth in their current positions. For this application, the dental model used to fabricate appliance 10 is a replica of the patient's current dental structure. Since the dental model has the same configuration as the patient's dental structure, appliance 10 would be applying essentially zero corrective force to the teeth when placed in the mouth. If one or more of the teeth relapse, or change location or orientation, then the appliance 10 can urge the wayward teeth back to their original positions.

In a second application, appliance 10 can be adapted to actively move teeth from current maloccluded positions to final, desired positions. More specifically, one or more portions of the arch member body 22 can be shaped to provide one or more corrective forces when the arch member couplings 24 are releasably connected to the anchor couplings 34. The inherent memory of the resilient arch member body 22 can provide corrective forces to one or more teeth as the shaped portions relax to their normal configuration. In this application, the dental model used to fabricate the appliance 10, therefore, represents the final dental arrangement envisioned by the treating professional.

In a third application, appliance 10 can be configured to move teeth to an intermediate, non-final dental arrangement. This situation may be encountered when the severity or complexity of the malocclusion is such that a single appliance is insufficient to reposition teeth from initial to final positions. In these cases, treatment may be conducted in multiple stages where a series of two or more arch members 20 are sequentially used with a single set of anchors 30 to incrementally and progressively move teeth from an initial maloccluded dental arrangement to a final corrected dental arrangement. Here, the dental model used to fabricate the appliance 10 can represent an intermediate dental arrangement that may be observed during the course of treatment.

In an exemplary embodiment of the third application, a first arch member 20 is connected to the anchors 30 to re-position a patient's maloccluded teeth to an intermediate dental arrangement. The first arch member 20 is then removed from the oral cavity. Next, a second arch member that has a configuration when relaxed that is different from the configuration of the first arch member when relaxed can be used in a similar fashion to re-position the patient's teeth from the intermediate dental arrangement to a final dental arrangement. If desired, the above process can be extended to two or more intermediate dental arrangements. In one or more embodiments, the first arch member and the second arch member can include the same configuration, but the second arch member can have material properties that are different from the first arch member. For example, one or more portions of the second arch member can include a stiffness that provides a corrective force or forces that are different from the corrective force or forces provided by the first arch member.

Dental models representing intermediate or final dental arrangements can be fabricated by manually forming, sectioning, and re-assembling a physical dental casting. Digital techniques can also be used. For example, a final dental arrangement can be determined using a computer algorithm or input from a treating professional, and one or more intermediate dental arrangements derived by sub-dividing the treatment into a series of discrete steps can be derived. In one or more embodiments, one or more of the intermediate dental arrangements can include a reduced image as is described, e.g., in U.S. Patent Publication No. 2010/0260405 (Cinader). Once each intermediate or final dental arrangement has been derived in such fashion, respective dental models may be directly fabricated using rapid prototyping methods. Each respective intermediate or final arch member 20 can be fabricated from the dental models using any suitable technique or combination of techniques.

In one or more embodiments that utilize progressive treatment of a patient's teeth, second, third, or more intermediate scans of the teeth can be performed using any suitable technique or combination of techniques. The practitioner or manufacturer can then utilize these intermediate scans to provide one or more additional arch members 20 that are adapted to provide one or more corrective forces to the teeth such that one or more teeth are repositioned to either a subsequent intermediate arrangement or a final target arrangement. Any suitable technique or combination of techniques can be utilized to provide these intermediate scans, models, and arch members, e.g., the techniques described in U.S. Patent Application Publication No. 2010/0260405 (Cinader Jr.) and U.S. Provisional Patent Application Ser. No. 62/097,733 (Atty. Docket No. 75174US002).

In general, an orthodontic appliance (e.g., appliance 10 of FIGS. 1-3) can be formed by providing a proposed specification of the orthodontic appliance, where the orthodontic appliance includes the arch member 20 that includes the arch member body 22 and the arch member coupling 24 connected to the arch member body. The appliance also includes a set of anchors 30, each anchor including the anchor coupling 34 and the base 32 adapted to connect the anchor to a surface of a tooth. Each arch member coupling 24 is releasably connectable to an anchor coupling 34, and further where at least one anchor 30 of the set of anchors is adapted for displacement relative to the arch member body 22 when the anchor is connected to the surface of the tooth and the anchor coupling is connected to an arch member coupling 24 of the arch member 20.

A first digital image representing a first dental arrangement associated with the orthodontic appliance 10 can be provided using any suitable technique or combination of techniques. A target digital image representing a target dental arrangement can be derived, e.g., by physically or virtually moving teeth in the first dental arrangement to one or more desired positions. The proposed specification of the orthodontic appliance 10 can be revised based at least in part on the target digital image. And the orthodontic appliance 10 can be formed based on the target digital image.

In one or more embodiments, a second digital image representing a second dental arrangement can be provided using any suitable technique or combination of techniques. At least one tooth in the second dental arrangement can be in a different position from the corresponding tooth in the first dental arrangement. A revised target digital image representing the second dental arrangement can be derived, e.g., by physically or virtually moving teeth in the first dental arrangement to desired positions. The proposed specification of the orthodontic appliance 10 can be revised based in part on the revised target digital image. And the orthodontic appliance 10 can be revised based on the revised proposed specification.

### Embodiments

1. An orthodontic appliance comprising:

a first anchor comprising an anchor coupling and a base adapted to connect the first anchor to a surface of a first tooth, and a second anchor comprising an anchor coupling and a base adapted to connect the second anchor to a surface of a second tooth; and an arch member comprising an arch member body and first and second arch member couplings connected to the body; wherein the first arch member coupling is releasably connectable to the anchor coupling of the first anchor and the second arch member coupling is releasably connectable to the anchor coupling of the second anchor, and further wherein the arch member body comprises a first nonlinear portion between the first arch member coupling and the second arch member coupling that is adapted to be spaced apart from the surfaces of the first and second teeth when the first and second anchors are connected to the surfaces of the first and second teeth and the first and second arch member couplings are releasably connected to the anchor couplings of the first and second anchors; and wherein the first anchor is adapted for displacement relative to the arch member body such that the first anchor can slide relative to the arch member body when the first and second anchors are connected to the surfaces of the first and second teeth and the first and second arch member couplings are releasably connected to the anchor couplings of the first and second anchors.

2. The appliance of embodiment 1, wherein the second anchor is adapted for displacement such that the second anchor can slide relative to the arch member body when the first and second anchors are connected to the surfaces of the first and second teeth and the first and second arch member couplings are releasably connected to the anchor couplings of the first and second anchors.
3. The appliance of any one of embodiments 1 to 2, wherein the base of the first anchor is adapted to connect the first anchor to a lingual surface of the first tooth.
4. The appliance of any one of embodiments 1 to 3, wherein the base of the second anchor is adapted to connect the first anchor to a lingual surface of the second tooth.
5. The appliance of any one of embodiments 1 to 4, wherein the anchor coupling of the first anchor comprises a post and the first arch member couplings comprises a recess adapted to releasably engage the post.
6. The appliance of embodiment 5, wherein the first arch member coupling further comprises a resilient liner disposed within the recess that is adapted to releasably engage the post of the first anchor coupling.
7. The appliance of any one of embodiments 1 to 6, wherein the first arch member coupling surrounds the anchor coupling of the first anchor when connected.
8. The appliance of any one of embodiments 1 to 4, wherein the first arch member coupling comprises a resilient tab and the anchor coupling of the first anchor comprises a slot adapted to receive the resilient tab such that the first anchor coupling is snap-fit to the first arch member coupling.
9. The appliance of embodiment 8, further comprising a clamp that is adapted to hold the resilient tab of the first arch member coupling in place in the slot of the anchor coupling of the first anchor.
10. The appliance of any one of embodiments 1 to 9, wherein the first arch member coupling further comprises a channel, wherein the arch member body is disposed within the channel.
11. The appliance of any one of embodiments 1 to 4, wherein the first arch member coupling comprises a slotted portion of the arch member body that is adapted to engage a recess of the anchor coupling of the first anchor.
12. The appliance of embodiment 11, wherein the recess of the anchor coupling of the first anchor comprises an undercut portion adapted to retain the slotted portion of the arch member body in the recess.
13. The appliance of any one of embodiments 11 to 12, wherein the slotted portion of the arch member body is resilient.
14. The appliance of any one of embodiments 11 to 13, wherein the slotted portion of the arch member body is adapted to slidably engage the recess of the anchor coupling of the first anchor.
15. The appliance of any one of embodiments 1 to 14, wherein the first anchor is adapted for displacement relative to the arch member body along the mesio-distal direction.
16. The appliance of any one of embodiments 1 to 15, wherein the first anchor coupling is adapted to provide at least one of a selected torque, rotation, and angulation to the first tooth when the first anchor is connected to the surface of the first tooth and the first arch member coupling is connected to the anchor coupling of the first anchor.
17. The appliance of any one of embodiment 1 to 16, wherein the arch member comprises a self-ligating arch member.
18. The appliance of any one of embodiments 1 to 17, wherein the first nonlinear portion extends in at least one of a gingival, occlusal, labial, and lingual direction when the first and second anchors are connected to the surfaces of the first and second teeth and the first arch member coupling and the second arch member coupling are connected to the anchor coupling of the first anchor and the anchor coupling of the second anchor respectively.
19. The appliance of any one of embodiments 1 to 17, wherein the first nonlinear portion extends in at least one of a labial and a lingual direction when the first and second anchors are connected to the surfaces of the first and second teeth and the first arch member coupling and the second arch member coupling are connected to the anchor coupling of the first anchor and the anchor coupling of the second anchor respectively.
20. The appliance of any one of embodiments 1 to 17, wherein the first nonlinear portion extends in at least one of a gingival and occlusal direction when the first and second anchors are connected to the surfaces of the first and second teeth and the first arch member coupling and the second arch member coupling are connected to the anchor coupling of the first anchor and the anchor coupling of the second anchor respectively.
21. The appliance of any one of embodiments 1 to 20, wherein the arch member body comprises a third arch member coupling and a second nonlinear portion between the second arch member coupling and the third arch member coupling, wherein a shape of the first nonlinear portion between the first and second arch member couplings is different from a shape of the second nonlinear portion between the second and third arch member couplings.
22. A method of forming an orthodontic appliance comprising:

providing a proposed specification of the orthodontic appliance, wherein the orthodontic appliance comprises an arch member that comprises an arch member body and an arch member coupling connected to the arch member body, and a set of anchors, each anchor comprising an anchor coupling and a base adapted to connect the anchor to a surface of a tooth, wherein each arch member coupling is releasably connectable to an anchor coupling, and further wherein at least one anchor of the set of anchors is adapted for displacement relative to the arch member body such the at least one anchor can slide relative to the arch member body when the anchor is connected to the surface of the tooth and the anchor coupling is connected to an arch member coupling of the arch member; providing a first digital image representing a first dental arrangement associated with the orthodontic appliance; deriving a target digital image representing a target dental arrangement; revising the proposed specification of the orthodontic appliance based at least in part on the target digital image; and forming the orthodontic appliance based on the revised proposed specification.

23. The method of embodiment 22, further comprising: providing a second digital image representing a second dental arrangement, wherein at least one tooth in the second dental arrangement is in a different position from the corresponding tooth in the first dental arrangement; deriving a revised target digital image representing the second dental arrangement; revising the proposed specification of the orthodontic appliance based in part on the revised target digital image; and forming the orthodontic appliance based on the revised proposed specification.
24. An orthodontic treatment system comprising an orthodontic appliance, wherein the orthodontic appliance comprises: a set of arch members, each arch member comprising an arch member body and an arch member coupling connected to the body; a set of anchors adapted to connect to respective teeth of a patient's dental arch, each anchor comprising an anchor coupling and a base adapted to connect the anchor to a surface of a tooth; wherein the arch member coupling is releasably connectable to an anchor coupling of an anchor of the set of anchors, and further wherein the anchor of the set of anchors is adapted for displacement relative to an arch member body of the arch member such that the anchor can slide relative to the arch member body when the anchor is connected to the surface of the tooth and the arch member coupling of the arch member is connected to the anchor coupling of the anchor, wherein the arch member body is adapted to not contact the surface of the tooth; and wherein a first arch member of the set of arch members has a geometry selected to move at least one tooth from a first arrangement to a second arrangement, and a second arch member of the set of arch members has a geometry selected to move at least one tooth from the second arrangement to a third arrangement.
25. The orthodontic treatment system of embodiment 24, wherein the surface of the tooth comprises a lingual surface of a tooth.
26. An orthodontic appliance comprising: an arch member comprising an arch member body and a plurality of arch member couplings connected to the body; and a plurality of anchors each comprising an anchor coupling and a base adapted to connect the anchor to a surface of a tooth; wherein each arch member coupling is releasably connectable to the anchor coupling of an anchor of the plurality of anchors, and further wherein at least one anchor is adapted for displacement relative to the arch member body such that the at least one anchor can slide relative to the arch member body when the anchor is connected to the surface of the tooth and an arch member coupling of the plurality of arch member couplings is connected to the anchor coupling; wherein the arch member body comprises a first shape between two arch member couplings that is different from a second shape between two additional arch member couplings, and further wherein the arch member body is adapted to not contact the surface of the tooth when the anchor of the plurality of anchors is connected to the surface of the tooth.
27. The appliance of embodiment 26, wherein the first shape of the arch member body is adapted to provide a first corrective force and the second shape is adapted to provide a second corrective force different from the first corrective force.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. An orthodontic appliance comprising:
a first anchor comprising an anchor coupling and a base adapted to connect the first anchor to a surface of a first tooth, and a second anchor comprising an anchor coupling and a base adapted to connect the second anchor to a surface of a second tooth; and
an arch member comprising an arch member body and first and second arch member couplings connected to the body;
wherein the first arch member coupling is releasably connectable to the anchor coupling of the first anchor and the second arch member coupling is releasably connectable to the anchor coupling of the second anchor, and further wherein the arch member body comprises a first nonlinear portion between the first arch member coupling and the second arch member coupling that is adapted to be spaced apart from the surfaces of the first and second teeth when the first and second anchors are connected to the surfaces of the first and second teeth and the first and second arch member couplings are releasably connected to the anchor couplings of the first and second anchors; and
wherein the first anchor is adapted for displacement relative to the arch member body such that the first anchor can slide relative to the arch member body when the first and second anchors are connected to the surfaces of the first and second teeth and the first and second arch member couplings are releasably connected to the anchor couplings of the first and second anchors.

2. The appliance of claim 1, wherein the arch member is a self-ligating arch member.

3. The appliance of claim 1, wherein the first nonlinear portion extends in at least one of a gingival, occlusal, labial, and lingual direction when the first and second anchors are connected to the surfaces of the first and second teeth and the first arch member coupling and the second arch member coupling are connected to the anchor coupling of the first anchor and the anchor coupling of the second anchor respectively.

4. The appliance of claim 1, wherein the arch member body comprises a third arch member coupling and a second nonlinear portion between the second arch member coupling and the third arch member coupling, wherein a shape of the first nonlinear portion between the first and second arch member couplings is different from a shape of the second nonlinear portion between the second and third arch member couplings.

5. The appliance of claim 1, wherein the first non-linear portion includes at least one of a hook, a twist, a step, a loop, and a spring.

6. The appliance of claim 1, wherein the first non-linear portion is at least one of U-shape, V-shaped, S-shaped, and sinusoidal.

7. The appliance of claim 1, wherein the first non-linear portion has a first shape adapted to provide a first corrective force to one or both teeth connected to the first and second arch member couplings.

8. The appliance of claim 7, wherein the second non-linear portion has a second shape that is adapted to provide a second corrective force to one or both teeth connected to the second and third arch member couplings.

9. The appliance of claim 8, wherein the first corrective force is different from the second corrective force.

10. The appliance of claim 1, wherein the first arch member coupling surrounds the anchor coupling of the first anchor when connected.

11. An orthodontic appliance comprising:
an arch member comprising an arch member body and a plurality of arch member couplings connected to the body; and
a plurality of anchors each comprising an anchor coupling and a base adapted to connect the anchor to a surface of a tooth;
wherein each arch member coupling is releasably connectable to the anchor coupling of an anchor of the plurality of anchors, and further wherein at least one anchor is adapted for displacement relative to the arch member body such that the at least one anchor can slide relative to the arch member body when the anchor is connected to the surface of the tooth and an arch member coupling of the plurality of arch member couplings is connected to the anchor coupling;
wherein the arch member body comprises a first shape between a first two arch member couplings that is different from a second shape between two additional arch member couplings, and further wherein the arch member body is adapted to not contact the surface of the tooth when the anchor of the plurality of anchors is connected to the surface of the tooth.

12. The appliance of claim 10, wherein the first shape of the arch member body is adapted to provide a first corrective force and the second shape is adapted to provide a second corrective force different from the first corrective force.

13. The appliance of claim 11, wherein the first shape includes a first cross-sectional geometry and the second shape includes a second cross-sectional geometry different from the first cross-sectional geometry.

14. The appliance of claim 11, wherein the arch member body includes a thickness, and wherein the thickness of the arch member body varies in a mesial-distal plane that is substantially orthogonal to a surface of the tooth when the arch member is connected to one or more teeth of the dental arch via the plurality of anchors.

15. The appliance of claim 11, wherein the arch member body includes a thickness, and wherein the thickness of the arch member body varies in a mesial-distal plane that is substantially parallel to a surface of the tooth when the arch member is connected to one or more teeth of the dental arch via the plurality of anchors.

16. The appliance of claim 11, wherein the first shape includes a first cross-sectional area and the second shape includes a second cross-sectional area different from the first cross-sectional area, the second shape providing a bending stiffness smaller than a bending stiffness of the first shape.

17. The appliance of claim 11, wherein the arch member body includes a cross-sectional area, and wherein the arch member coupling has a reduced cross-sectional area relative to the cross-sectional area of the arch member body.

18. The appliance of claim 17, wherein the arch member body includes a cross-sectional area, and wherein the arch member coupling has an enhanced cross-sectional area relative to the cross-sectional area of the arch member body.

19. The appliance of claim 11, wherein the first shape is adapted to provide a first corrective force to teeth coupled to the first two arch member couplings and the second shape is adapted to provide a first corrective force to teeth coupled to the additional two arch member couplings, and wherein the first corrective force is different from the second corrective force.

20. (canceled)

21. An orthodontic treatment system comprising an orthodontic appliance, wherein the orthodontic appliance comprises:
a set of arch members, each arch member comprising an arch member body and an arch member coupling connected to the body;
a set of anchors adapted to connect to respective teeth of a patient's dental arch, each anchor comprising an anchor coupling and a base adapted to connect the anchor to a surface of a tooth;
wherein the arch member coupling is releasably connectable to an anchor coupling of an anchor of the set of anchors, and further wherein the anchor of the set of anchors is adapted for displacement relative to an arch member body of the arch member such that the anchor can slide relative to the arch member body when the anchor is connected to the surface of the tooth and the arch member coupling of the arch member is connected to the anchor coupling of the anchor, wherein the arch member body is adapted to not contact the surface of the tooth; and
wherein a first arch member of the set of arch members has a geometry selected to move at least one tooth from a first arrangement to a second arrangement, and a second arch member of the set of arch members has a geometry selected to move at least one tooth from the second arrangement to a third arrangement.
